(19) United States
(12) Patent Application Publication
(10) Pub. No.: US 2007/0229472 A1
(43) Pub. Date: Oct. 4, 2007

(54) CIRCULAR SCROLLING TOUCHPAD FUNCTIONALITY DETERMINED BY STARTING POSITION OF POINTING OBJECT ON TOUCHPAD SURFACE

(76) Inventor: Jared G. Bytheway, Sandy, UT (US)

Correspondence Address: MORRISS OBRYANT COMPAGNI, P.C., 734 EAST 200 SOUTH, SALT LAKE CITY, UT, 84102, US

(21) Appl. No.: 11/693,154

(22) Filed: Mar. 29, 2007

Related U.S. Application Data
(60) Provisional application No. 60/787,554, filed on Mar. 30, 2006.

(51) Int. Cl. G06F 3/041

(52) U.S. Cl. 345/173

(57) ABSTRACT

A circular touchpad, or a touchpad of some other shape but having a circular scrolling region outlined thereon, wherein functions are defined as a button on the circular touchpad or within the circular scrolling region, wherein the function is actuated by touching down on the button, and then performing the function by moving a pointing object around the circular touchpad or the circular scrolling region, wherein movement causes the selected function to increase in a selected parameter or decrease in a selected parameter.

### CROSS REFERENCE TO RELATED APPLICATIONS

This document claims priority to and incorporates by reference all of the subject matter included in the provisional patent application docket number 3636.CIRQ.PR, having Ser. No. 60/787,554 and filed on Mar. 30, 2006.

### BACKGROUND OF THE INVENTION

1. Field of the Invention

This invention relates generally to touchpads and other data entry devices where touch by a finger or a stylus is used to enter data, access data, or otherwise manipulate data stored in an electronic device.

2. Description of Related Art

As portable electronic appliances become more ubiquitous, the need to efficiently control them is becoming increasingly important. The wide array of electronic devices include MP3 players, portable video players, digital cameras and camcorders, mobile telephones, and many different portable entertainment devices.

One of the main problems that many portable electronic appliances have is that their very size limits the number of ways in which communicating with the appliances is possible. One reason may be the very limited amount of space that is available. For example, mobile telephones that require a telephone number keypad are now replacing many personal digital assistants (PDAs). Typically, PDAs require a keyboard for data entry. The inventors of the present invention were involved in the discovery and development of a touchpad that is disposed underneath a telephone keypad. Hiding the keypad under the telephone keymat made the best possible use of the limited space available for data entry.

Other developers and users of portable electronic appliances have seen the benefits that come from using a circular touchpad. The very nature of a circular touchpad enables continuous motion in a single direction. Thus, lists of data can be scrolled in a single direction without stopping. Lists of data can include songs and playlists as popularized in some MP3 players. But lists can now include directories of contacts such as a phone directory stored in a mobile telephone. Thus, the applications of a circular touchpad extend beyond a single industry or application.

It should also be recognized that improved methods of data entry find application not only in small portable electronic appliances, but also in desktop or stationary devices.

One improvement to the circular touchpad is the ability to dispose buttons underneath certain locations along the circular path described by the touchpad. For example, play, pause, skip forward, skip backwards, and other discrete commands have been disposed under the circular touchpad of some MP3 and video players.

It is believed that there are other ways to improve data manipulation or input to a portable electronic appliance and even a desktop or stationary electronic device using a circular touchpad.

To understand the touchpad technology used in the present invention, it is useful to examine one embodiment of such technology. An important aspect of the present invention is the use of capacitance sensing technology for proximity sensing through the key cap. Touchpad technology of CIRQUE® Corporation has been adapted to perform this function. However, it should be remembered that the touchpad technology may be further modified for this particular invention.

The CIRQUE™ Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Pointing object position determination is then performed by using an equation that compares the magnitude of the two signals measured.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention.

The process above is repeated for the Y or column electrodes 14 using a P, N generator 24

Although the CIRQUE® touchpad described above uses a grid of X and Y electrodes 12, 14 and a separate and single sense electrode 16, the sense electrode can actually be the X or Y electrodes 12, 14 by using multiplexing. Either design will enable the present invention to function.

### BRIEF SUMMARY OF THE INVENTION

In a first embodiment, the present invention is a circular touchpad, or a touchpad of some other shape but having a circular scrolling region outlined thereon, wherein functions are defined as a button on the circular touchpad or within the circular scrolling region, wherein the function is actuated by touching down on the button, and then performing the function by moving a pointing object around the circular touchpad or the circular scrolling region, wherein movement causes the selected function to increase in a selected parameter or decrease in a selected parameter.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of a touchpad as taught be the prior art, and which is adapted to function with the present invention.

FIG. 2 is a top elevational view of an overlay that is disposed over a physical or virtual circular touchpad, showing assigned functions actuated upon touchdown thereon.

FIG. 3 is a top elevational view of another overlay that is disposed over a physical or virtual circular touchpad, showing assigned functions actuated upon touchdown thereon.

FIG. 4 is a top elevational view of another overlay that is disposed over a physical or virtual circular touchpad, showing assigned functions actuated upon touchdown thereon.

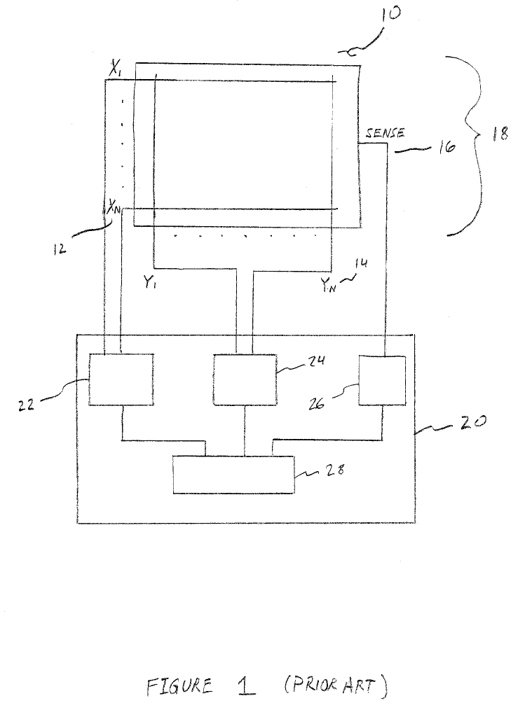

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

Circular touchpads can be described as being virtual or physical. The virtual circular touchpad is a touchpad that has a sensor area whose bounds are not circular, but instead has a circular region defined on it by firmware or other means for programming the function of the circular touchpad. For example, touchpad circuitry is able to determine when movement is occurring within a circular path. The circular path is made known to a user, for example, by applying an overlay on a surface of the touchpad.

In contrast, a physical circular touchpad is a touchpad that is designed so that the sensor area is physically formed as a ring or circular sensor area. As explained previously, a virtual or physical circular touchpad is useful for scrolling through lists in a non-linear manner, with the advantage being that movement can be continuous in any direction. However, it is the case in the prior art that the function that is performed by movement around the path defined by the circular touchpad has already been selected by some other means.

For example, when scrolling through a list, the list is already selected and any movement of a pointing object along the circular touchpad will cause the list to scroll up or down. In other cases, it may be that another input device can be used to switch functions of the data wheel. What is important about the prior art is that the function has not been selected by touching the circular touchpad. The only function being performed movement through a list, or incrementing or decrementing a particular value that is then translated to movement.

The present invention takes a different approach by adding a new function to the circular touchpad. The present invention enables the selection of a function to be performed by the act of touchdown by a pointing object on the surface of the circular touchpad in a specific location. The function that can be actuated by touchdown can be defined through firmware. In other words, specific locations on the circular touchpad can be programmed to be associated with different functions. These functions are arbitrarily assignable. A single function can be assigned to a circular touchpad, or multiple functions.

To enable a user to know where the circular touchpad must be touched in order to actuate a function, it is envisioned that an overlay will be disposed on the surface of the circular touchpad. Alternatively, the functions can be printed directly on the touchpad surface. In another alternative embodiment, an optically clear circular touchpad can be disposed, for example, on top of a display screen. This example will be explained later in more detail.

It is envisioned that the same or different types of functions may be actuated by touchdown on the circular touchpad in different locations. For example, touchdown on a first location may enable scrolling through a list of artists on an MP3 player. Touchdown on a second location may also enable scrolling, but through a different list such as playlists also stored on the MP3 player. Both of the functions are scrolling. However, the difference between the present invention and the prior art is that access to the lists is actuated by the mere act of touchdown on the circular touchpad in a specific location.

However, scrolling through lists is only one example of the functions that can be actuated through touchdown on the circular touchpad. It is envisioned that other functions can also be activated. Some examples of functions that can be actuated will include, but should not be considered to be limited to, adjustments to volume, adjusting an equalizer, adjusting brightness, adjusting contrast, adjusting speed forward or backward, skipping forwards and backwards among various items, zooming in or out, moving view up or down, channel selection up or down, screen movement up or down, advancing forwards or backwards through selectable items such as tools or weapons in a game and navigating forwards or backwards through web pages.

It is another aspect of the present invention that the functions that can be actuated may also be dynamically allocated to the surface of the circular touchpad. For example, consider a see-through circular touchpad that is disposed over or under a display screen. It is envisioned that the display screen can be programmed to display an overlay of functions that can be actuated by touchdown on dynamically assigned buttons that are displayed. Thus, a same location on the circular touchpad may activate a volume control in a first mode. The user may then be able to change to a second mode of operation. In the second mode of operation, the location where the volume button was displayed is no longer showing a “VOLUME” button, but is now showing a “ZOOM” button. In this second mode, touchdown on the ZOOM button will cause a ZOOM function to be performed, and not the VOLUME function.

Thus, the touchpad circuitry of the circular touchpad will enable volume to be adjusted when touchdown occurs on the VOLUME button, in the first mode, but changes to enable the ZOOM to be adjusted when the device is operating in a second mode, and the VOLUME button is changed to display a ZOOM button in the same location.

One of the portable electronic appliances that can be configured to take advantage of the present invention will include a mobile telephone. A user may be able to scroll through various lists stored within the memory of the mobile telephone, depending on which list is activated. These lists might be for pictures stored within the mobile telephone, a directory of stored names, a directory of received calls, a directory of called numbers, an address book, a date book, etc.

Other appliances that can take advantage of the present invention will include remote control devices, personal digital assistants (PDAs), personal game devices, cameras, camcorders, and even laptop computers. Computers can use the present invention to assist in navigation through menus. Productivity may be increased when using, for example, CAD (computer aided design) software where many nonlinear controls are needed with instant access, saving keystrokes or menu selections.

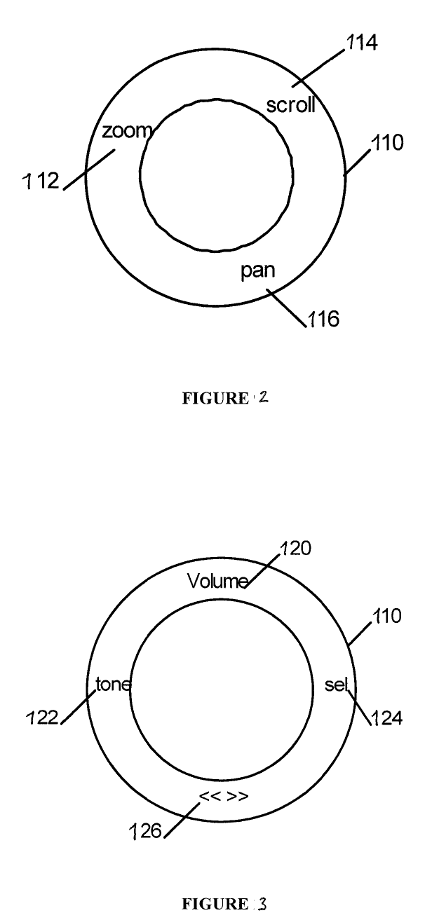

FIG. 2 is provided as an example of a circular touchpad overlay 110 that can be disposed over a virtual or a physical circular touchpad. In this figure, the buttons that are defined in firmware are zoom 112, scroll, 114 and pan 116. These functions are used when observing web pages, pictures and other visual data. Accordingly, such an overlay 110 might be used on a digital camera to view pictures or on a desktop computer to view web pages or pictures.

FIG. 3 is provided as an example of a circular touchpad overlay 110 that can be disposed over a virtual or a physical circular touchpad. In this figure, the buttons that are defined in firmware are volume 120, tone 122, selection 124, and seek (movement backwards or forwards through a song) 126. Such an overlay might be useful in an MP3 player or a desktop computer or laptop computer in a controller for a media player.

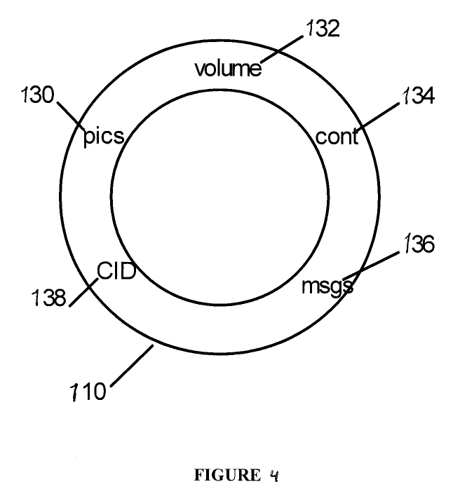

FIG. 4 is provided as an example of a circular touchpad overlay 110 that can be disposed over a virtual or a physical circular touchpad. In this figure, the buttons that are defined in firmware are pictures 130, volume 132, contacts 134, messages 136, and CID (caller identification) 138. Such an overlay may be useful for a PDA, a mobile telephone, and a desktop or laptop computer.

Another example is a remote control, such as for a television, DVD player, digital video recorder (DVR) or set top box. Set top boxes and DVRs are becoming very feature rich which presents a great challenge to navigating the features or searching through very large lists. The present invention may even be incorporated into an interface for many devices, such as stereos, DVD players, televisions, automobiles, etc.

It is also mentioned that while a circular touchpad has been described herein, other shapes are possible. The shape of the touchpad could be an oval, rectangle, square, figure eight pattern, or any desired polygon shape.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A system for enabling actuation and manipulation of functions by way of touchdown and non-linear movement around a path defined by a circular touchpad, said system comprising:
a circular touchpad;
touchpad circuitry for detecting touchdown by a pointing object on the circular touchpad; and
firmware associated with the touchpad circuitry, wherein the firmware defines at least one function to be activated when the pointing object makes touchdown on the circular touchpad in at least one pre-defined location.

2. The system as defined in claim 1 wherein the circular touchpad is a physically circular touchpad having sensors that are formed in a circular arrangement.

3. The system as defined in claim 1 wherein the circular touchpad is a virtually circular touchpad having sensors that are arranged in a non-circular arrangement.

4. The system as defined in claim 1 wherein the system is further comprised of an overlay disposed on a surface of the circular touchpad that outlines a circular area for traversing the touchpad with the pointing object, and wherein the overlay offers a visual display of the at least one pre-defined location where touchdown will actuate the at least one function.

5. The system as defined in claim 1 wherein the system is further comprised of a display screen, wherein the circular touchpad is disposed on top of the display screen, and wherein the circular touchpad is optically clear such that the display screen is visible through the optically clear circular touchpad.

6. The system as defined in claim 5 wherein the display screen is further comprised of an image that is shown on the display screen, wherein the image functions as the equivalent of an overlay, wherein the display screen offers a visual display of the at least one pre-defined location where touchdown will actuate the at least one function.

7. The system as defined in claim 6 wherein the display screen is further comprised of a dynamic image overlay, wherein different images enable the display screen to display different overlays.

8. The system as defined in claim 1 wherein the system is further comprised of devices that can receive input from the circular touchpad, said devices being selected from the group of devices comprised of MP3 players, mobile telephones, remote control devices, personal digital assistants (PDAs), personal game devices, cameras, camcorders and laptop computers.

9. The system as defined in claim 1 wherein the at least one function to be activated is selected from the group of functions comprised of adjustments to volume, adjusting an equalizer, adjusting brightness, adjusting contrast, adjusting speed forward or backward, skipping forwards and backwards among various items, zooming in or out on a display, moving a view up or down on a display, channel selection up or down, screen movement up or down, advancing forwards or backwards through selectable items such as tools or weapons in a game, and navigating forwards or backwards through web pages.

10. A method for activating and manipulating functions by way of touchdown and non-linear movement around a path defined by a circular touchpad, said method comprising the steps of:
(1) providing a circular touchpad, touchpad circuitry for detecting touchdown by a pointing object on the circular touchpad, and firmware associated with the touchpad circuitry, wherein the firmware defines at least one function to be activated when the pointing object makes touchdown on the circular touchpad in at least one pre-defined location; and
(2) touching the circular touchpad on at least one pre-defined location to thereby activate the at least one function associated therewith.

11. The method as defined in claim 10 wherein the method further comprises the step of providing a physically circular touchpad having sensors that are formed in a circular arrangement.

12. The method as defined in claim 10 wherein the method further comprises the step of providing a virtually circular touchpad having sensors that are arranged in a non-circular arrangement.

13. The method as defined in claim 10 wherein the method further comprises the step of providing an overlay disposed on a surface of the circular touchpad that outlines a circular area for traversing the touchpad with the pointing object, and wherein the overlay offers a visual display of the at least one pre-defined location where touchdown will actuate the at least one function.

14. The method as defined in claim 10 wherein the method further comprises the step of providing a display screen, wherein the circular touchpad is disposed on top of the display screen, and wherein the circular touchpad is optically clear such that the display screen is visible through the optically clear circular touchpad.

15. The method as defined in claim 10 wherein the method further comprises the step of providing an image that is shown on the display screen, wherein the image functions as the equivalent of an overlay, wherein the display screen offers a visual display of the at least one pre-defined location where touchdown will actuate the at least one function.

16. The method as defined in claim 10 wherein the method further comprises the step of providing a dynamic image overlay, wherein different images enable the display screen to display different overlays.

17. The method as defined in claim 10 wherein the method further comprises the step of selecting a device that can receive input from the circular touchpad from the group of devices comprised of MP3 players, mobile telephones, remote control devices, personal digital assistants (PDAs), personal game devices, cameras, camcorders and laptop computers.

18. The method as defined in claim 10 wherein the method further comprises the step of selecting the at least one function to be activated from the group of functions comprised of adjustments to volume, adjusting an equalizer, adjusting brightness, adjusting contrast, adjusting speed forward or backward, skipping forwards and backwards among various items, zooming in or out on a display, moving a view up or down on a display, channel selection up or down, screen movement up or down, advancing forwards or backwards through selectable items such as tools or weapons in a game, and navigating forwards or backwards through web pages.

19. A method for activating and manipulating functions by way of touchdown and movement around a path defined by a touchpad, said method comprising the steps of:
(1) providing a touchpad, touchpad circuitry for detecting touchdown by a pointing object on the touchpad, and firmware associated with the touchpad circuitry, wherein the firmware defines at least one function to be activated when the pointing object makes touchdown on the touchpad in at least one pre-defined location; and
(2) touching the touchpad on at least one pre-defined location to thereby activate the at least one function associated therewith.

20. The method as defined in claim 19 wherein the method further comprises the step of selecting the touchpad from the group of touchpads comprised of an oval, rectangle, square, figure eight pattern, or any other polygon shape.

21. The method as defined in claim 19 wherein the method further comprises the step of providing an overlay disposed on a surface of the touchpad that outlines an area for traversing the touchpad with the pointing object, and wherein the overlay offers a visual display of the at least one pre-defined location where touchdown will actuate the at least one function.

22. The method as defined in claim 19 wherein the method further comprises the step of providing a display screen, wherein the touchpad is disposed on top of the display screen, and wherein the touchpad is optically clear such that the display screen is visible through the optically clear touchpad.

23. The method as defined in claim 19 wherein the method further comprises the step of providing an image that is shown on the display screen, wherein the image functions as the equivalent of an overlay, wherein the display screen offers a visual display of the at least one pre-defined location where touchdown will actuate the at least one function.

24. The method as defined in claim 19 wherein the method further comprises the step of providing a dynamic image overlay, wherein different images enable the display screen to display different overlays.

25. The method as defined in claim 19 wherein the method further comprises the step of selecting a device that can receive input from the touchpad from the group of devices comprised of MP3 players, mobile telephones, remote control devices, personal digital assistants (PDAs), personal game devices, cameras, camcorders and laptop computers.

26. The method as defined in claim 19 wherein the method further comprises the step of selecting the at least one function to be activated from the group of functions comprised of adjustments to volume, adjusting an equalizer, adjusting brightness, adjusting contrast, adjusting speed forward or backward, skipping forwards and backwards among various items, zooming in or out on a display, moving a view up or down on a display, channel selection up or down, screen movement up or down, advancing forwards or backwards through selectable items such as tools or weapons in a game, and navigating forwards or backwards through web pages.

27. A system for enabling actuation and manipulation of functions by way of touchdown and movement around a path defined by a touchpad, said system comprising:
a touchpad;
touchpad circuitry for detecting touchdown by a pointing object on the touchpad; and
firmware associated with the touchpad circuitry, wherein the firmware defines at least one function to be activated when the pointing object makes touchdown on the touchpad in at least one pre-defined location.
